(19) United States
(12) Patent Application Publication
(10) Pub. No.: US 2007/0089965 A1
(43) Pub. Date: Apr. 26, 2007

(54) Parking system of a hybrid vehicle

(76) Inventors: Kyung Won Hwang, Euijeongbu-city (KR); Yeon Ho Kim, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,766

(22) Filed: Dec. 15, 2005

(30) Foreign Application Priority Data
Oct. 20, 2005 (KR) 10-2005-0099194

(51) Int. Cl. B60T 1/06

(52) U.S. Cl. 192/219.5

(57) ABSTRACT

A parking system of a hybrid vehicle includes a traction motor that rotates an output shaft of the transmission, a parking gear rotated by the output shaft, a sprag selectively engaged with the parking gear, an actuator that moves the sprag, and a control portion that controls the traction motor, wherein the control portion operates the traction motor when the sprag and the parking gear are not disengaged by the actuator. A method for releasing a parking lock includes detecting operation of a shift lever, operating an actuator to move a sprag, detecting whether the sprag is disengaged from the parking gear, and operating a traction motor if the sprag is not disengaged.

### CROSS-REFERENCE TO RELATED APPLICATION

This application claims priority to and the benefit of Korean Patent Application No. 10-2005-0099194 filed in the Korean Intellectual Property Office on Oct. 20, 2005, the entire contents of which are incorporated herein by reference.

### BACKGROUND OF THE INVENTION

(a) Field of the Invention

The present invention relates to a parking system of a hybrid vehicle using a traction motor to release a parking lock. More particularly, when a shift lever is pushed but a sprag fails to disengage from a parking gear, a traction motor disengages the sprag.

(b) Description of the Related Art

Generally, an automatic transmission vehicle has a parking system that engages a sprag with a parking gear, which is fixedly coupled to an output shaft of a vehicle, when a shift lever is in the P range. When the parking lever is moved to the P range, a parking rod connected to the shift lever moves the sprag. Then, the sprag is engaged with a parking gear, establishing a parking lock.

Typically, such a parking system is designed to lock when the output shaft rotates slower than a predetermined lower limit speed.

Hereinafter, a conventional process of engaging the sprag with the parking gear will be described briefly. Power for moving the sprag can be delivered through a shift cable from the shift lever, or can be delivered from a shift control motor.

Firstly, a vehicle speed is measured when a driver moves a shift lever to a P range. The measured vehicle speed is compared with a predetermined lower limit speed for allowing parking lock. If the measured vehicle speed is slower than the lower limit speed, a transmission control unit operates the shift control motor. When the shift control motor is operated, a parking rod moves and the sprag is engaged with the parking gear.

To release the parking lock, the shift control motor is rotated in the opposite direction. The power is delivered to the sprag through the shift cable or shift control motor so as to disengage the sprag from the parking gear.

The above system is problematic when the force is insufficient to disengage the sprag. Especially when the sprag is engaged with the parking gear near the lower limit speed for allowing parking lock, excessive engaging force is generated. Therefore, the sprag may not be disengaged from the parking gear.

When such a problem occurs in a vehicle having a conventional parking lock system, a driver should shift the shift lever from P rage to R range after pushing and moving the vehicle. It is very uncomfortable for the driver.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a parking system of a hybrid vehicle using a traction motor having advantages of easily releasing a parking lock when a sprag is not disengaged from a parking gear.

A parking system of a hybrid vehicle using a traction motor according to an exemplary embodiment of the present invention includes a traction motor that rotates an output shaft of the transmission, a parking gear rotated by the output shaft, a sprag selectively engaged with the parking gear, an actuator that moves the sprag, and a control portion that controls the traction motor, wherein the control portion operates the traction motor when the sprag and the parking gear are not disengaged by the actuator. The actuator may include a shift control motor or a shift cable.

A method for releasing a parking lock according to an exemplary embodiment of the present invention includes detecting an operation of the shift lever; operating an actuator so as to move a sprag; detecting whether the sprag is disengaged from the parking gear; and operating a traction motor when the sprag is disengaged from the parking gear.

### DESCRIPTION OF THE DRAWINGS

FIG. 1 is a schematic diagram of a parking system according to an exemplary embodiment of the present invention.

FIG. 2 is a schematic partial diagram of a parking system according to an exemplary embodiment of the present invention.

FIG. 3 is a flow chart of a process for releasing a parking lock according to an embodiment of the present invention in which a shift control motor is used as an actuator.

FIG. 4 is a flow chart of a process for releasing a parking lock according to an embodiment of the present invention in which a shift cable is used as an actuator.

### DETAILED DESCRIPTION OF THE PREFERRED EMBODIMENTS

An exemplary embodiment of the present invention will hereinafter be described in detail with reference to the accompanying drawings.

An actuator 150 delivers a force that moves a sprag 108 when the shift lever 10 is moved from a P range to an R range. The actuator 150 may include a shift cable or a shift control motor.

If a shift cable is used as an actuator 150, the operation force of the shift lever is mechanically delivered to the sprag through the shift cable to move the sprag 108.

If a shift control motor is used as an actuator 150, a paring-by-wire system is constructed in which the shift control motor operates the parking lock when a driver shifts the shift lever 10.

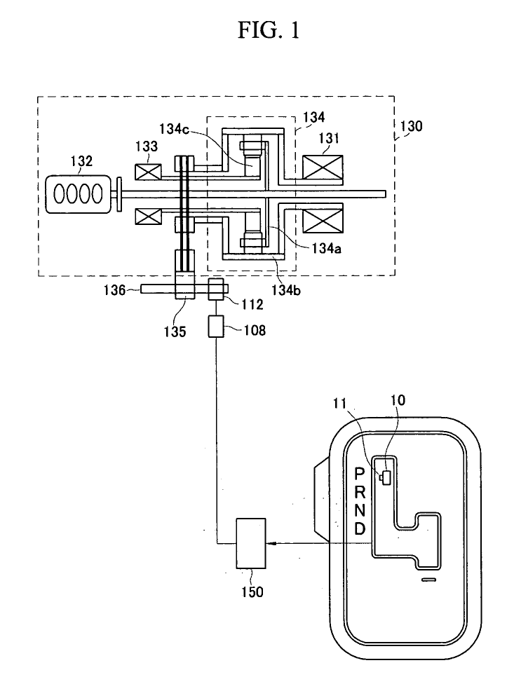

Reference numeral 130 in FIG. 1 indicates a transmission installed in a hybrid vehicle.

Generally, a hybrid vehicle includes an engine 132, a generator 133 that charges a battery (not shown), a traction motor 131 connected to the battery and used for vehicle driving or charging the battery, and a transmission control unit that controls the traction motor 131. The traction motor 131 is generally used for going forward or backward at the start of driving. When the vehicle moves backward, only the traction motor 131 is used.

A planetary gear set 134 is installed between the engine 132 and the traction motor 131 so as to deliver the rotation force to the output shaft 136 through a differential 135. Reference numeral 134a is a carrier, reference numeral 134b is a ring gear, and reference numeral 134c is a sun gear.

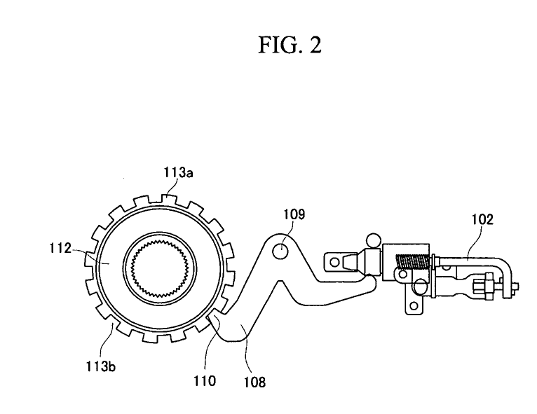

The output shaft 136 is coupled to a parking gear 112. The parking gear 112 is rotatable along with the output shaft. The parking gear 112 may be directly coupled to the output shaft 136 as shown in FIG. 2. However, the parking gear can be fixed to another shaft offset from the output shaft, and can be connected with other subsidiary gears.

Therefore, the power for rotating the parking gear 112 is delivered from the traction motor 131 to the parking gear 112, and when the sprag is not disengaged from the parking gear, the parking lock can be released by operating the traction motor without moving the vehicle.

The parking gear is controlled by a control portion; the transmission control unit can be used as the control portion.

Hereinafter, the structure of the parking gear and the sprag will be described in more detail with reference to the FIG. 2.

The parking gear 112 is directly or indirectly rotated by a rotation of an output shaft, and has a plurality of teeth 113a and recessed portions 113b formed thereon.

The sprag 108 has a projection portion 110 at one end selectively inserted in one of the recessed portions 113b.

The sprag 108 rotates around a hinge 109, and the end opposite the projecting portion 110 is connected to the parking rod 102.

Therefore, when the parking rod 102 is moved, the sprag 108 rotates around the hinge 109.

One end of the parking rod 102 is connected to the actuator 150. The actuator may include a shift control motor of a shift cable. Since a structure and a method for changing rotational motion to a motion in a straight line is obvious for a person with ordinary skill in the art, a detailed description of the structure or method for delivering a rotational force of the shift control motor to the parking rod 102 will be omitted. Since a structure and a method for mechanically delivering a force from the shift lever to the parking rod through the shift cable is obvious for a person with ordinary skill in the art, a detailed description will be omitted.

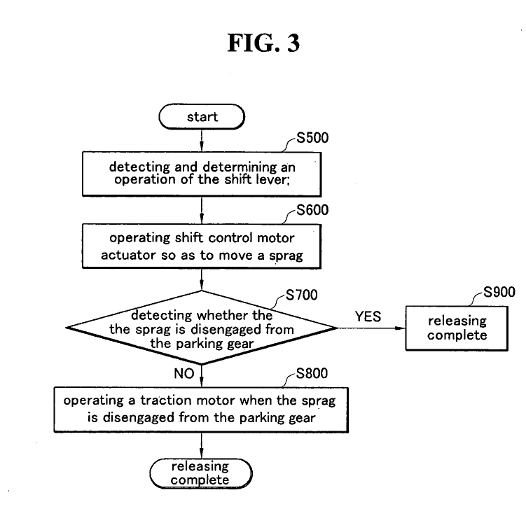

Hereinafter, referring FIG. 3, a process for releasing the parking lock according to a first exemplary parking system of the present invention in which a shift control motor is used as the actuator will be described.

Firstly, an operation of the shift lever is detected and determined in step S500. Here, “determining operation of the shift lever” means “determining whether a driver is trying to shift the shift lever from P range to R range.” For example, when a driver pushes a button of the shift lever, it can be detected as an operation of the shift lever. Alternatively, when a driver pushes a button of the shift lever and applies a force to the shift lever in the direction of the R range, it can be determined as an operation of the shift lever. A method for detecting and determining the operation of the shift lever is obvious for a person of an ordinary skill in the art.

When the shift lever is determined to be operated, the transmission control unit operates the shift control motor to release the parking lock in step S600. The shift control motor rotates in a direction for disengaging the sprag from the parking gear. However, if the engaging force of the sprag and the parking gear is bigger than the rotating force of the shift control motor, the sprag is not disengaged from the parking gear, maintaining the parking lock state.

Subsequently, the sprag detecting part (not shown) detects and determines whether the sprag is disengaged from the parking gear in step S700. The determining of the disengaging of the sprag from the parking gear may comprise detecting a position of the sprag or detecting a rotational angle of the sprag with respect to the hinge.

If the sprag is disengaged from the parking gear, the parking lock is released without operating the traction motor in step S900.

However, if the sprag is still engaged with the parking gear, the traction motor is operated, and the subsidiary force generated by the traction motor disengages the sprag from the parking gear in step S800.

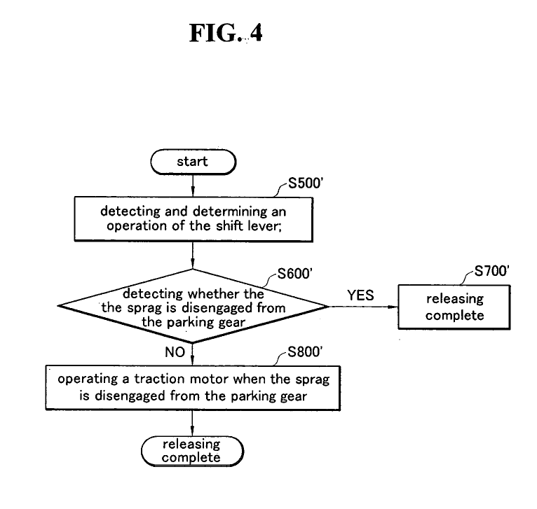

Hereinafter, referring FIG. 4, a process for releasing the parking lock according to a second exemplary parking system of the present invention in which a shift cable is used as the actuator will be described.

Firstly, an operation of the shift lever is detected and determined in step S500′. Then, the sprag measuring part detects and determines whether the sprag is disengaged from the parking gear in step S600′. When engaging force of the sprag and the parking gear is bigger than the force delivered through the shift wire, the sprag is not disengaged from the parking gear. On the other hand, when the engaging force of the sprag and the parking gear is smaller than the force delivered through the shift cable, the sprag is disengaged from the parking gear.

If the sprag is disengaged from the parking gear, the parking lock is released without operating the traction motor in step S700′.

However, if the sprag is still engaged with the parking gear, the traction motor is operated, and the subsidiary force generated by the traction motor disengages the sprag from the parking gear in step S800′.

The sprag can be engaged with the parking gear when the vehicle moves forward or backward. The traction motor can rotate both directions. Therefore, the traction motor can be used in all cases.

According to the present invention, the sprag can be easily disengaged from the parking gear.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A parking system, comprising:
a traction motor that rotates an output shaft of a transmission;
a parking gear rotated by a rotation of the output shaft;
a sprag selectively engaged with the parking gear;
an actuator that moves the sprag; and
a control portion that controls the traction motor such that the traction motor rotates the parking gear when the sprag is not disengaged from the parking gear by the actuator.

2. The parking system of claim 1, wherein the actuator comprises a shift control motor.

3. The parking system of claim 1, wherein the actuator comprises a shift cable.

4. A method for releasing a parking lock, comprising:
detecting an operation of a shift lever;
operating an actuator that moves a sprag;
detecting whether the sprag had been disengaged from a parking gear; and
operating a traction motor to rotate the parking gear if the sprag has not been disengaged from the parking gear.

5. The method of claim 4, wherein
detecting whether the sprag has been disengaged from a parking gear comprises detecting a position of the sprag.

6. The method of claim 4, wherein the detecting an operation of a shift lever comprises detecting whether a button of the shift lever is pushed.

7. The method of claim 4, wherein
the actuator comprises a shift control motor.

8. The method of claim 4, wherein
the actuator comprises a shift cable.
